(19) United States
(12) Patent Application Publication
(10) Pub. No.: US 2013/0099153 A1
(43) Pub. Date: Apr. 25, 2013

(54) HYBRID MATERIAL COMPRISING GRAPHENE AND IRON OXIDE, METHOD FOR MANUFACTURING THE SAME, AND APPARATUS FOR TREATING WASTE WATER USING THE SAME

(71) Applicants: Kwang Soo KIM, Pohang-si (KR); Jung Woo Lee, Pohang-si (KR); Chandra Vimlesh, Pohang-si (KR); In Chul Hwang, Pohang-si (KR); Young Chun, Seoul (KR)

(72) Inventors: Kwang Soo KIM, Pohang-si (KR); Jung Woo Lee, Pohang-si (KR); Chandra Vimlesh, Pohang-si (KR); In Chul Hwang, Pohang-si (KR); Young Chun, Seoul (KR)

(73) Assignee: POSTECH ACADEMY-INDUSTRY FOUNDATION, Pohang-city (KR)

(21) Appl. No.: 13/279,291

(22) Filed: Oct. 23, 2011

(51) Int. Cl. C02F 1/48; C02F 101/20; B82Y 40/00; B82Y 99/00; B82Y 25/00

(52) U.S. Cl. 252/62.56; 977/734; 977/902; 977/840; 977/773

(57) ABSTRACT

A hybrid material including graphene and iron oxide, a method of manufacturing the same, and an apparatus for treating waste water using the same are provided. A hybrid material having magnetic properties and high dispersibility and including graphene and iron oxide may be effectively used for removing a heavy metal in waste water.

### CROSS-REFERENCE TO RELATED APPLICATION

The entire contents of Korean Patent Application No. 10-2010-0038705 filed in the Korean Intellectual Property Office on Apr. 26, 2010 are incorporated herein by reference.

### BACKGROUND

(a) Field of the Invention

A hybrid material including graphene and an iron oxide, a method of manufacturing the same, and an apparatus for treating waste water using the same are disclosed.

(b) Description of the Related Art

Magnetic separation using magnetic properties is much more selective and efficient than centrifugation and filtration. Magnetic separation has been integrated with rapidly-developing nanotechnology and used to purify drinking water or industrial water contaminated with heavy metals such as arsenic and the like using nanoparticles with magnetic properties.

However, the magnetic separation using nanoparticles with magnetic properties removes more than 99.9% of arsenic trivalent and heptavalent ions, which is not appropriate for drinking water and industrial water.

The reason is that magnetic particles have no fine and uniform size, and thus do not efficiently remove heavy metals, and also, they may become entangled due to insecure thermal and/or chemical stability of coating agents for the magnetic particles.

### SUMMARY

A novel hybrid material including graphene and an iron oxide, and a method of manufacturing the same are provided.

In addition, an apparatus for treating waste water using the same is provided, which may effectively remove a heavy metal in waste water.

According to one exemplary embodiment of the present invention, a hybrid material including graphene and an iron oxide and having magnetic properties and high dispersibility is provided.

The iron oxide may include magnetite.

The hybrid material may have a particle diameter of about 1 nm to about 20 nm.

The hybrid material may have a specific surface area ranging from about 300 m²/g to about 600 m²/g.

The hybrid material may be used to remove a heavy metal in waste water.

According to another embodiment of the present invention, an apparatus for treating waste water using the hybrid material is provided.

According to yet another embodiment of the present invention, provided is a method of manufacturing a hybrid material including graphene and an iron oxide, which includes (a) preparing a graphene oxide, (b) dispersing the graphene oxide in water to prepare a first dispersion, (c) adding divalent iron (Fe) and trivalent iron (Fe) to the first dispersion to prepare a second dispersion, (d) adjusting pH of the second dispersion to be about 8 to about 11 at about 25° C., (e) heating a the second dispersion obtained from the process (d) up to about 80 to about 110° C., and adding a reducing agent to the second dispersion obtained from the process (e) to prepare a hybrid material including graphene and an iron oxide.

The first dispersion in the process (b) may have a concentration of about 100 to about 500 parts by weight of the graphene oxide based on 100 parts by weight of the water.

The divalent iron and the trivalent iron included in the process (c) may be added in a ratio ranging from about 1:1.5 to about 1:2.5.

The second dispersion in the process (c) may have a concentration of about 0.002 to about 1200 parts by weight of the divalent iron and the trivalent iron based on 100 parts by weight of the water.

The divalent iron and trivalent iron may be salts.

The divalent iron may be at least one selected from the group consisting of FeCl₂, FeBr₂, FeI₂ FeCO₃, Fe(NO₃)₂, FeO, and FeSO₄.

The trivalent iron may be at least one selected from the group consisting of FeCl₃, FeBr₃, FeI₃, Fe(NO₃)₃, Fe₂O₃, and Fe₂(SO₄)₃.

The reducing agent in the process (f) may be at least one selected from the group consisting of hydrazine (N₂H₄), NaBH₄, KBH₄, NaAlH₄, KAlH₄, and hydroquinone (C₆O₂H₆).

The hybrid material including graphene and an iron oxide may be magnetic and highly dispersible.

The iron oxide may include magnetite.

The hybrid material may have a particle diameter of about 1 nm to about 20 nm.

The hybrid material may have a specific surface area of about 300 m²/g to about 600 m²/g.

The hybrid material may be used to remove a heavy metal in waste water.

The heavy metal may be at least one selected from the group consisting of arsenic (As), cadmium (Cd), mercury (Hg), antimony (Sb), and bismuth (Bi).

According to still another embodiment of the present invention, an apparatus for treating waste water using a hybrid material prepared in the aforementioned method is provided.

Therefore, the present invention provides a fine and uniform hybrid material including graphene and an iron oxide, which may be applied to mass production.

In addition, the hybrid material may be used to effectively remove a heavy metal in waste water.

### BRIEF DESCRIPTION OF THE DRAWINGS

FIG. 1 provides the optical microscope photograph of a hybrid material according to Example 2.

FIG. 2 provides the scanning microscope photograph of the hybrid material according to Example 2.

FIG. 3 shows the X-ray diffraction data of the hybrid material according to Example 2.

FIG. 4 is the photograph showing the magnetic agglomeration properties of the hybrid material according to Example 2.

### DETAILED DESCRIPTION

Exemplary embodiments of the present invention will hereinafter be described in detail. However, these embodiments are only exemplary, and the present invention is not limited thereto.

In this specification, a term “graphene” indicates a polycyclic aromatic molecule formed by a plurality of carbon atoms connected through a covalent bond. The carbon atoms connected through the covalent bond form a 6-membered ring as a basic repeating unit, but may also form 5-membered rings and/or 7-membered rings. Accordingly, the graphene appears as a single layer formed of carbon atoms (commonly, an sp2 bond) connected through the covalent bond. The graphene may have various structures depending on the amount of 5-membered rings and/or 7-membered rings therein. The graphene may be formed of a single layer, but multi-layers in which several layers are laminated as a “graphene sheet” may be formed, and thus may be at most about 100 nm thick. In general, the graphene has a side terminal end saturated with hydrogen atoms.

The graphene may be simply separated from inexpensive graphite, and thus is very economical.

According to one embodiment of the present invention, a hybrid material including graphene and an iron oxide and having magnetic properties and high dispersibility is provided.

The graphene may be prepared by a person of ordinary skill in the art, for example, in a method developed by William S. Hummers. Any commercially available method of manufacturing graphene may be used for one embodiment of the present invention.

The iron oxide may be magnetite.

Magnetite is an isometric mineral and has magnetic properties, and thus become a natural magnet.

The magnetite has a chemical compound of Fe₃O₄. The magnetite may include titanium (Ti). In addition, the magnetite may include manganese, phosphorous, magnesium, and the like. The magnetite may in general have a massive phase, a granular phase, a sand phase, or a lamellar phase.

The hybrid material may include an iron oxide having a particle diameter of about 1 nm to about 20 nm. The hybrid material may be used to remove a heavy metal in waste water as described later. The hybrid material may effectively remove a heavy metal in waste water when an iron oxide therein has a diameter within the range. The iron oxide may be magnetite. When the hybrid material includes an iron oxide with a particle diameter of more than about 20 nm, a heavy metal may be impossible to remove from waste water.

A hybrid material with the particle diameter may have a specific surface area ranging from about 300 to about 600 m²/g.

When the hybrid material has a specific surface area within the range, more heavy metal in waste water may be absorbed therein. Accordingly, the increased adsorption of the hybrid material may remove more than about 90% of a heavy metal from waste water. Preferably, the hybrid material may absorb and remove more than about 99.9% of a heavy metal from waste water.

Therefore, the hybrid material may be used to remove a heavy metal in waste water.

Examples of the heavy metal may include at least one selected from the group consisting of arsenic (As), cadmium (Cd), mercury (Hg), antimony (Sb), bismuth (Bi), and ionic oxides thereof.

Another embodiment of the present invention provides an apparatus for treating waste water using the hybrid material. The apparatus for treating waste water may treat waste water having pH of about 4 to about 9. The reason is that the hybrid material according to one embodiment of the present invention has excellent pH stability.

According to still another embodiment of the present invention, a method is provided for preparing a hybrid material including graphene and an iron oxide, which includes (a) preparing a graphene oxide, (b) dispersing the graphene oxide in water to prepare a first dispersion, (c) adding divalent iron (Fe) and trivalent iron (Fe) to the first dispersion to prepare a second dispersion, (d) adjusting pH of the second dispersion to be about 8 to about 11 at about 25° C., (e) heating the second dispersion obtained from the process (d) up to about 80 to about 110° C., and adding a reducing agent to the second dispersion obtained from the process (e) to prepare a hybrid material including graphene and an iron oxide.

The graphene oxide obtained in the process (a) may be a medium product obtained during the graphene manufacturing process. In addition, the graphene oxide may be prepared by a person who has ordinary skill in the art as described above. For example, the graphene oxide may be prepared in a method developed by William S. Hummers.

The graphene oxide has excellent dispersibility in water. In addition, graphene, a reduced product of the graphene oxide, has excellent dispersibility in water. Accordingly, the graphene may compensate the dispersibility of a hybrid material including the graphene and iron oxide in water, which the iron oxide may not do.

In other words, the first dispersion in the process (b) may include a graphene oxide uniformly dispersed in water.

The first dispersion in the process (b) may have a concentration of about 100 to about 500 parts by weight of the graphene oxide based on 100 parts by weight of the water. When the graphene oxide is included within the range, a hybrid material may be effectively prepared to be sufficiently uniform. When the graphene oxide is included beyond the range, the graphene oxide may have no effective reaction with iron ions.

As shown in the process (c), divalent and trivalent irons are added to the first dispersion, preparing a second dispersion. In this process, a raw material of an iron oxide is added to prepare the hybrid material.

Herein, the divalent and trivalent irons are first mixed and then added, because magnetite is Fe³⁺[Fe²⁺Fe³⁺]O₄ including a molecule of Fe₃O₄.

The divalent and trivalent irons in the process (c) are mixed in a ratio ranging from about 1:1.5 to about 1:2.5. When the divalent and the trivalent irons are mixed within the range, magnetite may have an advantageous particle diameter size and composition ratio.

The second dispersion in the process (c) has a concentration of more than about 0.002 or more, or about 0.002 to about 1200 parts by weight of the divalent and trivalent irons based on 100 parts by weight of the water. In other words, a hybrid material including an iron oxide (e.g., magnetite) may be effectively prepared by using a very small amount of divalent and trivalent irons and may be used to remove a heavy metal in waste water. The upper range of the divalent and trivalent irons is limited on the ground that is similar to that of the graphene oxide in the first dispersion, considering a ratio with the amount of the graphene oxide.

The divalent and trivalent irons may be of a salt type. However, the divalent and trivalent irons may not necessarily be of a salt type, but may be iron oxide (e.g., FeO or Fe₂O₃) with a solid phase and the like.

Examples of the divalent iron may include FeCl₂, FeBr₂, FeI₂ FeCO₃, Fe(NO₃)₂, FeO, FeSO₄, and the like, and examples of the trivalent iron may include FeCl₃, FeBr₃, FeI₃, Fe(NO₃)₃, Fe₂O₃, Fe₂(SO₄)₃, and the like.

As shown in the process (d), the second dispersion may be adjusted to have pH of about 8 to about 11 at about 25° C. When the second dispersion has pH within the range, a hybrid material may remove iron anions.

The process (d) may use a compound such as ammonia, NH₄OH, KOH, NaOH, and the like to adjust pH. In addition, the process (d) may accompany agitation (stirring).

As shown in the process (e), the second dispersion with adjusted pH in the process (d) may be heated up to a temperature ranging from about 80 to about 100° C. The heating is performed at a speed ranging from about 1.0° C./min to 10° C./sec for about 10 to about 90 minutes.

When the heating is performed within the range, a hybrid material may be effectively synthesized in the process (d).

The process (e) may also accompany agitation.

A reducing agent may be added to the second dispersion heated in the process (e), the same as in the process (f).

Examples of the reducing agent in the process (f) may include hydrazine (N₂H₄), NaBH₄, KBH₄, NaAlH₄, KAlH₄, hydroquinone (C₆O₂H₆), and the like.

The process (f) may also accompany agitation. In addition, the second dispersion including a reducing agent may be cooled down to room temperature (25° C.) during the agitation. Herein, the agitation may be performed for about 1 to about 6 hours. The agitation time within the range is required to produce sufficient hybrid materials.

Hereinafter, the cooled final dispersion including a hybrid material is filtered to obtain a hybrid material, and the hybrid material may be washed with water and alcohol.

Then, the washed hybrid material is dried at a temperature ranging from about 60 to about 90° C. for about 2 to about 6 hours. The drying process may be performed for about 1 to about 2 hours under vacuum. When the drying is performed within the range, a hybrid material may be sufficiently dried. When the drying is performed at higher than the temperature range, there may be a side reaction.

The obtained hybrid material including graphene and an iron oxide may be magnetic and highly dispersible. In particular, the hybrid material may be very dispersible in water.

The hybrid material is described in detail in the aforementioned embodiment of the present invention and is thus omitted here.

Another embodiment of the present invention provides an apparatus for treating waste water manufactured using a hybrid material prepared in the aforementioned method. As aforementioned, the apparatus for treating waste water may treat waste water with pH ranging from about 4 to about 9.

Hereinafter, the embodiments are illustrated in more detail with reference to examples. However, the following are exemplary embodiments and are not limiting.

### EXAMPLES

### Example 1

### Preparation of Graphene Oxide

A graphene oxide was prepared in a Hummer method. In other words, a graphene oxide was prepared by oxidizing graphite powder.

First, graphite powder was mixed with NaNO₃ in a sulfuric acid solution in a reactor. The mixture was fervently agitated at 0° C. Next, KMnO₄ powder was slowly added to the agitated mixture at a temperature of lower than 15° C.

The mixture was diluted with distilled water while being maintained at 35° C., and then 30% hydrogen peroxide (H₂O₂) was slowly added thereto at room temperature.

Then, the prepared graphene oxide was centrifuged and washed several times with 10% hydrochloric acid (HCl). The washed graphene oxide powder was vacuum-dried at room temperature.

### Example 2

### Preparation of Hybrid Material Including Graphene and Iron Oxide (M1-G)

The graphene oxide according to Example 1 was dispersed into water. Herein, the amount of water was 500 mg, while the amount of dispersed graphene oxide was 700 mg.

Then, FeCl₃.6H₂O and FeCl₂.4H₂O solutions was added to the water in which graphene oxide was dispersed. Herein, bivalent Fe was added in an amount of 1.3 g, while trivalent Fe was added in an amount of 3.2 g.

Next, a 30% ammonia aqueous solution was added to the solution at room temperature to adjust the solution to pH of 10.

Then, the solution was heated up to 90° C., and hydrazine hydrate was added thereto while being regularly agitated. The addition of the hydrazine prepared a black dispersion solution.

The black dispersion solution was quickly agitated for 4 hours and cooled to room temperature. Then, the dispersion solution was filtered and washed with water and ethanol, and then vacuum-dried at 70° C., obtaining a hybrid material.

The hybrid material with a graphene multi-layer had a magnetite particle diameter of 10 nm.

The hybrid material was called M1-G and was used experimentally regarding arsenic ion removal.

### Example 3

### Preparation of Hybrid Material Including Graphene and Iron Oxide (M2-G)

The graphene oxide according to Example 1 was dispersed into water. Herein, the water was used in an amount of 500 mg, and the graphene oxide was dispersed in an amount of 700 mg.

Next, FeCl₃.6H₂O and FeCl₂.4H₂O solutions were added to the water in which the graphene oxide was dispersed. Herein, bivalent Fe was added in an amount of 0.013 g, and trivalent Fe was added in an amount of 0.032 g.

Then, a hybrid material with a graphene multi-layer was prepared by performing the rest of the manufacturing process as in Example 2, and had a magnetite particle diameter of 10 nm.

The hybrid material was called M2-G and was used experimentally regarding arsenic removal.

### Comparative Example 1

### Conventional Particle for Removing Arsenic

A conventional material according to Comparative Example 1 was prepared in a method described in Cafer T. Yavuz, et al., Science 314, 964, (2006), and W. W. Yu, et al., Chemical Communications, 2306 (October 2004). The material had magnetite (Fe₃O₄) particles ranging from 4 nm to 15 nm formed through a thermal decomposition reaction (320° C.) of oleic acid with FeO(OH) (ferric oxyhydroxide) in a 1-octadecene solution.

### Experimental Example

Optical Microscope and Scanning Microscope Photographs

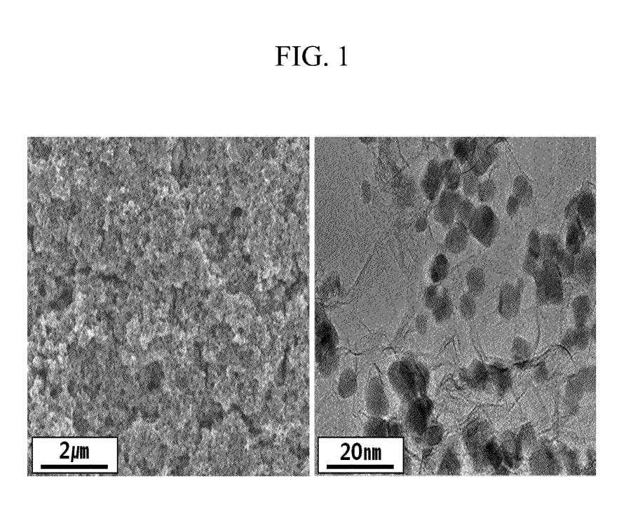

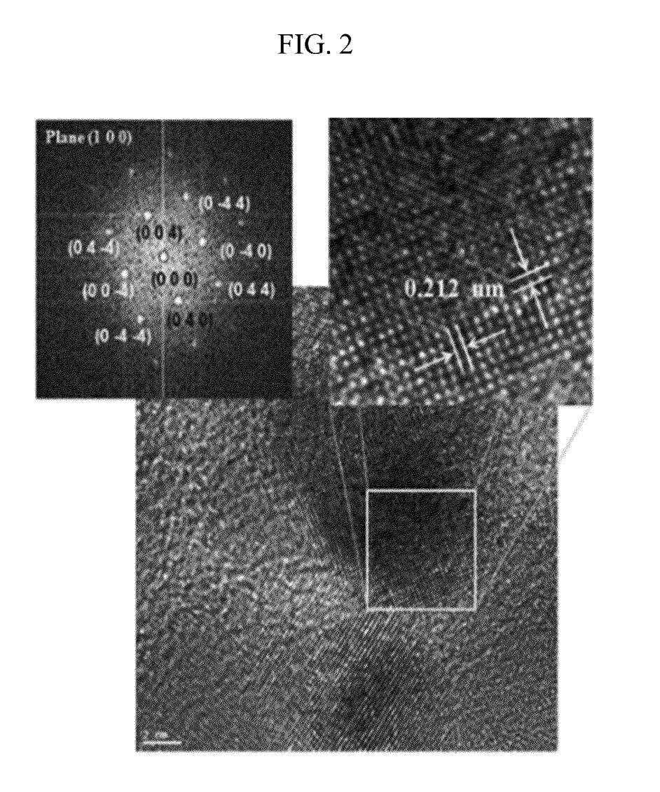

FIG. 1 provides optical microscope photographs of the hybrid material according to Example 2, and FIG. 2 provides scanning microscope photographs of the hybrid material according to Example 2.

As shown in FIGS. 1 and 2, the hybrid material uniform had particles with a fine size.

Electron Energy-Loss Spectroscopy (EELS) Data

EELS data of the hybrid material according to Example 2 is provided.

The electron energy-loss spectroscopy showed iron (Fe) and oxygen (O) atom percentages respectively of 43.75% and 56.25% through integration analysis of peaks at inherent energy values (eV) of the iron (Fe) and the oxygen (O) relative to magnetite, indicating that the hybrid material was magnetite (Fe₃O₄).

X-Ray Diffraction Analysis

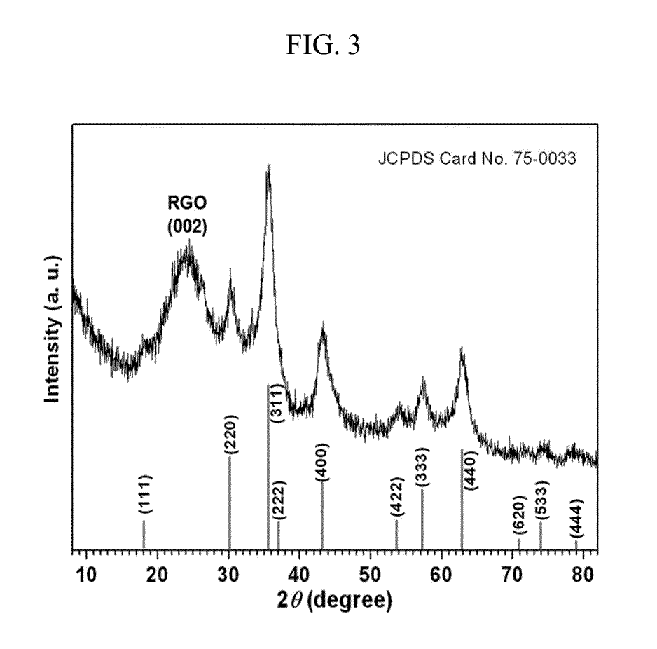

FIG. 3 provides the X-ray diffraction results of the hybrid material according to Example 2.

The X-ray diffraction pattern shows the hybrid material particles had the same diffraction index as magnetite and graphene.

The X-ray diffraction peak shape showed that the particles were typical nano-sized particles.

Photograph of Magnetic Agglomeration Properties of Hybrid Material of Example 2 at Each Process

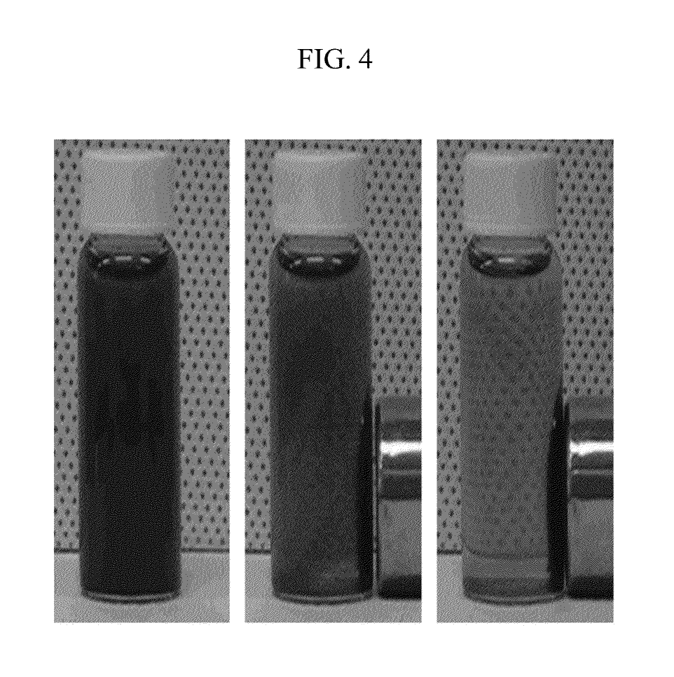

FIG. 4 provides photographs showing magnetic agglomeration properties of the hybrid material according to Example 2 at each process.

As shown in the photographs, the hybrid material according to Example 2 was agglomerated toward iron when the iron became close to a dispersion solution in which the hybrid material was dispersed.

In other words, the experiment showed that the hybrid material had excellent magnetic properties.

Arsenic Removal Experiment in Waste Water Using Hybrid Materials According to Examples 2 and 3

The hybrid materials according to Examples 2 and 3 were respectively extracted in an amount of 0.1 g.

0.1 g of the extracted hybrid materials according to Examples 2 and 3 included magnetites of 50 mg (M1-G) and 0.5 mg (M2-G). In other words, the magnetites in each extracted hybrid material were present in a ratio of 100:1. The extracted hybrid materials were respectively dispersed into 100 ml of water.

The hybrid material dispersion solutions were respectively added to solutions with different arsenic ion concentrations and examined regarding concentration change of arsenic ions.

The following Table 1 shows arsenic ion (As³⁺ and As⁵⁺) removal efficiency of each hybrid material (magnetite-graphene).

TABLE 1

| | | | Remaining | |
|---|---|---|---|---|
| | | Initial arsenic | arsenic | % As |
| Hybrid | As (III)/ | concentration | concentration | removal |
| material | As (V) | Conc. (μg/L) | (μg/L) | rate |
| M1-G | As (III) | 1330 | <1.00 | >99.9 |
| M1-G | As (V) | 540 | <1.00 | >99.8 |
| M2-G | As (III) | 1330 | <1.00 | >99.9 |
| M2-G | As (V) | 540 | <1.00 | >99.8 |

As shown in Table 1, a hybrid material according to an exemplary embodiment of the present invention included a small amount of magnetite but had an arsenic removal rate in waste water of more than 99.9%.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

What is claimed is:

1. A hybrid material comprising graphene and iron oxide, and having magnetic properties and high dispersibility.

2. The hybrid material of claim 1, wherein the iron oxide comprises magnetite.

3. The hybrid material of claim 1, wherein the hybrid material comprises iron oxide having a particle diameter of about 1 nm to about 20 nm.

4. The hybrid material of claim 1, wherein the hybrid material has a specific surface area ranging from about 300 m²/g to about 600 m²/g.

5. The hybrid material of claim 1, wherein the hybrid material is used for removing heavy metal in waste water.

6. An apparatus for treating waste water using the hybrid material according to claim 1.

7. A method of manufacturing a hybrid material including graphene and iron oxide, comprising:
(a) preparing a graphene oxide;
(b) dispersing the graphene oxide in water to prepare a first dispersion;
(c) adding divalent iron (Fe) and trivalent iron (Fe) to the first dispersion to prepare a second dispersion;
(d) adjusting pH of the second dispersion to be about 8 to about 11 at about 25° C.;
(e) increasing the temperature of the second dispersion obtained from the (d) process up to about 80 to about 110° C.; and
(f) adding a reducing agent to the second dispersion obtained from the (e) process to prepare a hybrid material including graphene and iron oxide.

8. The method of claim 7, wherein the first dispersion in the process (b) has a concentration of about 100 to about 500 parts by weight of the graphene oxide based on 100 parts by weight of the water.

9. The method of claim 7, wherein the divalent iron and the trivalent iron in the process (c) are added in a ratio ranging from about 1:1.5 to about 1:2.5.

10. The method of claim 7, wherein the second dispersion in the process (c) has a concentration of about 0.002 to about 1200 parts by weight of the divalent iron and the trivalent iron based on 100 parts by weight of the water.

11. The method of claim 7, wherein the divalent iron and trivalent iron are salts.

12. The method of claim 11, wherein the divalent iron is at least one selected from the group consisting of FeCl₂, FeBr₂, FeI₂, FeCO₃, Fe(NO₃)₂, FeO, and FeSO₄.

13. The method of claim 11, wherein the trivalent iron is at least one selected from the group consisting of FeCl₃, FeBr₃, FeI₃, Fe(NO₃)₃, Fe₂O₃, and Fe₂(SO₄)₃.

14. The method of claim 7, wherein the reducing agent in the process (f) is at least one selected from the group consisting of hydrazine (N₂H₄), NaBH₄, KBH₄, NaAlH₄, KAlH₄, and hydroquinone (C₆O₂H₆).

15. The method of claim 7, wherein the hybrid material including graphene and iron oxide is magnetic and highly dispersible.

16. The method of claim 7, wherein the iron oxide comprises magnetite.

17. The method of claim 7, wherein the hybrid material has a particle diameter ranging from about 1 nm to about 20 nm.

18. The method of claim 7, wherein the hybrid material has a specific surface area ranging from about 300 m²/g to about 600 m²/g.

19. The method of claim 7, wherein the hybrid material is used to remove heavy metal in waste water.

20. The method of claim 19, wherein the heavy metal is at least one selected from the group consisting of arsenic (As), cadmium (Cd), mercury (Hg), antimony (Sb), and bismuth (Bi).

21. An apparatus for treating waste water manufactured by using the hybrid material prepared in any method according to claim 7.
